(19) United States
(12) Patent Application Publication
(10) Pub. No.: US 2025/0378233 A1
(43) Pub. Date: Dec. 11, 2025

(54) SUPER PAN WITH PA CONDITION EMBEDDING

(71) Applicant: MEDIATEK INC., HSINCHU (TW)

(72) Inventors: TZU-HSUAN WEI, HSINCHU (TW); HAO YUN CHEN, HSINCHU (TW); YI-MIN TSAI, HSINCHU (TW); CHENG-HAO TSAI, HSINCHU (TW); LIN SEN WANG, HSINCHU (TW)

(21) Appl. No.: 18/738,145

(22) Filed: Jun. 10, 2024

(51) Int. Cl. G06F 30/27; G06F 119/06

(52) U.S. Cl. CPC G06F 30/27; G06F 2119/06

(57) ABSTRACT

In an aspect of the disclosure, a method, a computer-readable medium, and an apparatus are provided. The apparatus may be a computing device. The computing device receives a condition indication representing power amplifier configuration settings. The computing device receives an input signal. The computing device generates an output signal based on the condition indication and the input signal using a main neural network architecture including a series of convolution blocks. The output signal simulates an amplified signal in accordance with the input signal and the power amplifier configuration settings.

### BACKGROUND

### Field

The present disclosure relates generally to communication systems, and more particularly, to techniques of using a neural network architecture with a conditional embedding branch to model power amplifier behavior under various conditions.

### Background

In most radio frequency (RF) communication systems, power amplifiers (PAs) are a major source of nonlinear and memory effects that can cause severe spectral regrowth. Spectral regrowth significantly degrades the signal quality due to high out-of-band power. Memory effects cause asymmetricity in a transmitted signal. These problems become critical issues for the nextgeneration 5G technologies. Moreover, in an edge device of 5G communication systems, both the high transmission power and the limited supply voltage can worsen the non-linearity of power amplifiers.

A Power Amplifier Network (PAN) is a neural network model used to simulate the behavior of a real power amplifier (PA). The PAN takes an input signal, and outputs a simulated amplified signal, aiming to closely match the output of the real PA for the given input signal.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a computing device. The computing device receives a condition indication representing power amplifier configuration settings. The computing device receives an input signal. The computing device generates an output signal based on the condition indication and the input signal using a main neural network architecture including a series of convolution blocks. The output signal simulates an amplified signal in accordance with the input signal and the power amplifier configuration settings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a Power Amplifier Network (PAN) system.

FIG. 2 is a diagram illustrating a Super PAN (SPAN) with conditional embedding branch.

FIG. 3 is a flow chart of a method (process) for operating a power amplifier network.

FIG. 4 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

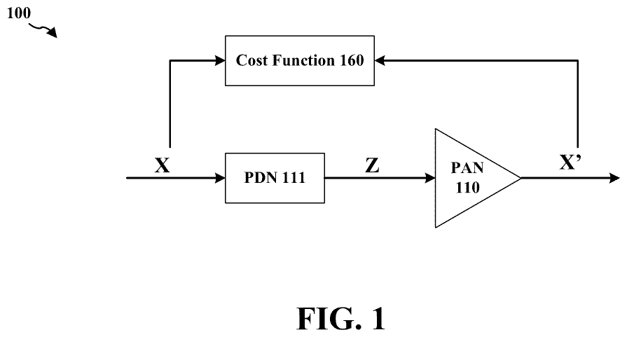

FIG. 1 is a diagram 100 illustrating a Power Amplifier Network (PAN) system designed to simulate and optimize the behavior of a real power amplifier using a neural network approach.

An input signal X is fed into a Predistortion Network (PDN) 111. X represents the original input signal, typically in I/Q data format, that is intended to be amplified by a power amplifier. The PDN 111 applies predistortion to the input signal X. Predistortion is used to counteract the nonlinear characteristics and memory effects of the power amplifier, thereby improving the linearity of the output signal. The PDN 111 processes the input signal X and outputs a pre-distorted signal Z. The pre-distorted signal Z has been modified to compensate for the expected distortions caused by the power amplifier. The signal Z is then fed into the Power Amplifier Network (PAN) 110. The PAN 110 simulates the behavior of the actual power amplifier. It takes the pre-distorted signal Z as input and produces an output signal X′, which is the simulated amplified signal. The PAN 110 is modeled to closely replicate the characteristics of a specific power amplifier under various operating conditions. The output signal X′ is the final output of the system, representing the amplified signal as it would appear after being processed by an actual power amplifier.

The output signal X′ from the PAN 110 is compared against the desired signal using a cost function 160. The cost function 160 calculates the error or difference between the output signal X′ and a desired output. This error measurement is used to adjust and train the PDN 111 and/or PAN 110, enhancing their accuracy and effectiveness in simulating and compensating for the power amplifier's behavior. Feedback from the cost function 160 is used to continuously train and optimize the PDN 111 and/or PAN 110.

This system is beneficial in communication systems where high fidelity and linearity of the amplified signals are needed, such as in advanced wireless communication technologies including 5G. The ability to simulate and optimize amplifier behavior in software allows for more efficient design and testing of power amplifiers, potentially accelerating development cycles and reducing the need for extensive physical prototyping.

In a first technique, a PAN is designed and trained to simulate the behavior of a single, specific power amplifier (PA) under a fixed set of conditions or configurations. That is, the PAN can only model a single PA condition per neural network, requiring multiple networks to cover different conditions. This limitation hinders the efficiency and practicality of the system, as Power Amplifiers often operate under various physical and signal-related settings, such as bandwidth and modulation This limitation restricts the versatility and adaptability of the model, requiring separate PAN instances for different PAs or varying operating conditions.

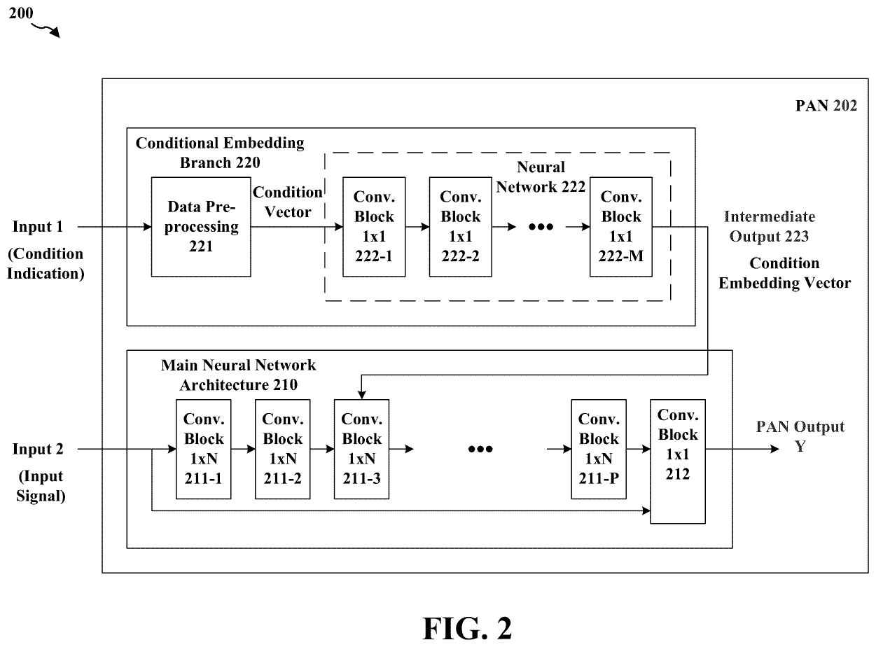

FIG. 2 is a diagram 200 illustrating a PAN 202 according to a second technique, which is denoted Super PAN (SPAN) with conditional embedding branch. The PAN 202 provides a generalized model capable of simulating a variety of Power Amplifier (PA) conditions using a single neural network. This is achieved through the introduction of a conditional embedding branch that encodes information from PA conditions. The conditional embedding branch processes the PA settings and generates an intermediate output that is fed into the main neural network architecture. This allows the PAN to adapt to different PA conditions without the need for multiple separate networks.

More specifically, in this example, the PAN 202 includes a main neural network (NN) architecture 210 and a conditional embedding branch 220. The main NN architecture 210 includes a series of 1×N convolution blocks 211-1, 211-2, . . . , 211-P and a 1×1 convolution block 212. For example, P is 6. The conditional embedding branch 220 includes a data pre-processing component 221 and a series of 1×1 convolution blocks 222-1 to 222-M. For example, M is 2.

Further, each block of the series of 1×N convolution blocks 211-1, 211-2, . . . , 211-P includes a 1×N convolution (Conv), followed by a Layer Normalization (LayerNorm), and a Gaussian Error Linear Unit (GELU) activation function. This architecture is designed to incorporate both spatial and channel-wise features.

The 1×N convolution operation in each block is responsible for extracting spatial features from the input signal. It performs a convolution operation with a kernel size of 1×N, where N is the size of the convolutional filter in one dimension. This allows the network to learn and capture patterns or dependencies along the spatial dimension of the input signal. In essence, it scans the input signal with a window of size N, computing the weighted sum of the signal values within that window. This process allows the network to learn local patterns and features in the signal. The choice of kernel size N influences the receptive field of the convolution, determining how much context the network considers when extracting features.

The LayerNorm is applied after the 1×N convolution to normalize the activations across the channel dimension. It stabilizes the training process and improve the convergence of the network. LayerNorm normalizes the activations by computing the mean and variance across the channel dimension and then applies a linear transformation to scale and shift the normalized activations.

The GELU activation function is used after the LayerNorm to introduce non-linearity into the network. GELU is a smooth approximation of the ReLU activation function. It allows the network to learn more complex representations and capture non-linear relationships in the data.

The combination of 1×N Conv, LayerNorm, and GELU in each block enables the Super PAN main NN architecture to effectively process and learn from the input signal. The 1×N Conv extracts spatial features, the LayerNorm normalizes the activations, and the GELU introduces non-linearity, allowing the network to capture both spatial and channel-wise dependencies.

The structure of the convolution blocks replaces the commonly used 1×3 convolution with 1×7 or 1×5 convolutions in the lower dimensions of the network. This allows the network to capture a larger receptive field and learn more complex spatial patterns.

The structure of the convolution blocks uses as the activation function instead of PRELU (Parametric Rectified Linear Unit). GELU may provide better performance and stability in deep learning models compared to other activation functions.

The structure of the convolution blocks employs LayerNorm instead of BatchNorm for normalization. LayerNorm normalizes the activations across the channel dimension, while BatchNorm normalizes across the batch dimension.

The conditional embedding branch 220 includes a series of 1×1 convolution blocks 222-1 to 222-M. As described infra, The 1×1 convolution block may efficiently encode the Power Amplifier (PA) condition information while maintaining a compact representation. The 1×1 convolution operation, also known as pointwise convolution, applies a linear transformation to each individual channel of the input tensor. In the conditional embedding branch 220, the 1×1 convolution blocks serve the purpose of encoding the PA condition information into a compact embedding vector.

The second technique, i.e., SPAN with conditional embedding branch, improves upon the first technique by providing a generalized model capable of simulating a variety of PA conditions using a single neural network. This is achieved through the introduction of the conditional embedding branch 220 that encodes information from PA conditions.

In the first technique, a separate PAN is required for each PA setting or condition, which can be numerous. This limitation hinders the efficiency and practicality of the system, as it requires multiple models to cover different conditions. The SPAN addresses this issue by incorporating a conditional embedding branch 220 that allows the PAN 202 to adapt to different PA conditions without the need for multiple separate networks.

The conditional embedding branch 220 processes the PA settings, such as band, modulation, and other configuration parameters, and generates an intermediate output that is fed into the main neural network architecture 210. This enables the SPAN to model the behavior of different PAs under various conditions using a single model.

More specifically, Input 1, which is a condition indication, is fed into the data pre-processing component 221. The data pre-processing component 221 converts the condition indication into a condition vector. The condition indication represents the PA configuration setting parameters, which may include one or more of.
Band: The frequency band in which the PA operates (e.g., Band 77, Band 79).
Modulation: The modulation scheme used for the signal (e.g., DFT, CP).
Cons: The constellation type (e.g., QPSK, 64QAM).
RB Allocation: The resource block allocation (e.g., Outer, Inner).
Central freq.: The central frequency of the signal.
Pout: The output power level of the PA.
MIPI: The Mobile Industry Processor Interface (MIPI) control settings.
Vpa: The PA supply voltage.

The parameters Band, Modulation, Cons, and RB Allocation have a limited set of possible values. On the other hand, the parameters Central freq, Pout, MIPI, and Vpa are continuous, represented by numerical values without a predefined limit.

These parameters are exemplified in the following table:

| | | | RB | Central | | | |
|---|---|---|---|---|---|---|---|
| Band | Modulation | Cons | Allocation | freq. | Pout | MIPI | Vpa |
| 77 | DFT | QPSK | Outer | X | X | X | X |
| | | | (xxRB0) | | | | |
| 79 | CP | 64QAM | Inner | | | | |
| | | | (xxRBxx) | | | | |

These parameters are combined to form a specific condition indication, such as: n77_3330_DFT_60_64QAM_312_162RB0_26_MIPI_18_Vpa_3.3V

This condition indication represents a PA operating in Band 77, with a central frequency of 3330 MHz, using DFT modulation, 64QAM constellation, 60 resource blocks, 162 outer resource blocks, 26 dBm output power, MIPI setting of 18, and a supply voltage of 3.3V.

The data pre-processing component 221 in the conditional embedding branch 220 of the PAN 202 takes the condition indication as input and converts it into the condition vector. This conversion process involves extracting the relevant information from the condition indication string and mapping it to the corresponding numerical values in the condition vector.

For example, the condition indication

n77_3330_DFT_60_64QAM_312_162RB0_26_MIPI_18_Vpa_3.3V is processed by the data pre-processing component 221 to generate the condition vector [77, 3330, 1, 64, 0, 26, 18, 3.3]. The data pre-processing component 221 identifies the values for each parameter based on the predefined format of the condition indication string. Each element in the vector corresponds to a specific parameter of the PA condition indication. In this example, the elements of the condition vector are as follows:
77: Represents the frequency band in which the PA operates, in this case, Band 77.
3330: Represents the central frequency of the signal in MHz.
1: Represents the modulation scheme used for the signal. In this example, 1 corresponds to DFT modulation.
64: Represents the constellation type, which is 64QAM in this case.
0: Represents the resource block allocation. 0 indicates outer resource blocks (xxRB0).
26: Represents the output power level of the PA in dBm.
18: Represents the Mobile Industry Processor Interface (MIPI) control settings.
3.3: Represents the PA supply voltage in volts.

The resulting condition vector serves as a compact and numerical representation of the PA configuration settings. The condition vector allows the PAN 202 to adapt to different PA conditions by providing the necessary information about the PA configuration settings in a format that can be understood and utilized by the neural network. This enables the PAN 202 to simulate the behavior of the PA under various operating conditions using a single model, as opposed to requiring separate models for each PA condition.

The condition vector is then fed into the series of 1×1 convolution blocks 222-1 to 222-M in the conditional embedding branch 220. These 1×1 convolution blocks encode the PA condition information into a compact embedding vector. The 1×1 convolution operation applies a linear transformation to each individual element of the condition vector, enabling the network to learn and adapt to different PA conditions.

The weights of the 1×1 convolution blocks are learned during the training process of the neural network. The architecture and operation of the 1×1 convolution blocks are predefined, but the specific weights are determined through the training process. This allows the conditional embedding branch to learn the appropriate transformations to encode the PA condition information effectively.

The output of the conditional embedding branch 220 is the condition embedding vector, which is an intermediate output. It is a tensor vector with a shape of [1, 1024, 8] in the given example. This condition embedding vector represents the PA configuration information in a format that can be understood and utilized by the main NN architecture 210.

The dimensions of the tensor vector [1, 1024, 8] represent:
1: This indicates a single batch or instance of data being processed. In this example, it indicates that the tensor vector corresponds to a single input sample or a single set of PA configuration settings.
1024: This dimension represents the depth or the number of features extracted and encoded by the conditional embedding branch. It encapsulates a significant amount of information about the PA condition in a compressed form.
8: This dimension corresponds to the number of different parameters or aspects of the PA condition that are being encoded. Each element in this dimension can represent a different characteristic of the PA, such as modulation type, power output settings, etc.

The condition embedding vector has a higher dimensionality compared to the input condition vector. This increased dimensionality allows the neural network to learn more complex representations and capture the necessary information for adapting to different PA conditions.

The condition embedding vector is suitable for the machine learning or deep learning model. The neural network can effectively process and utilize this condition embedding vector to adapt its behavior based on the PA condition information.

The condition embedding vector is then fed into the main NN architecture 210 at a specific point, such as being concatenated with the output of one of the 1×N convolution blocks 211-1 to 211-P. This allows the main NN architecture 210 to incorporate the PA condition information and adapt its processing accordingly, enabling the PAN 202 to simulate the behavior of the PA under various operating conditions using a single model.

Further, an Input 2, which is a signal, is fed into the main NN architecture 210, which processes the input signal and generates an output signal. The input signal may be a tensor vector with a shape of [Batch size, 1, 1024, 2], where:
Batch size: This dimension represents the number of signal instances being processed simultaneously. It is a user-defined parameter that determines how many sets of signals are fed into the network at once. For example, if the batch size is set to 10, the network will process 10 sets of signals in parallel.
1: This dimension indicates the number of channels in the input signal. In this case, it is set to 1, representing a single channel.
1024: This dimension represents the length or number of samples in each signal instance.
2: This dimension corresponds to the I/Q (In-phase and Quadrature) components of the signal. The signal is represented as a complex number, with the real part (I) and the imaginary part (Q).

The input signal passes through the series of Conv 1×N blocks 211-1 to 211-P followed by the last Conv 1×1 block 212. Each Conv 1×N block applies a 1×N convolution operation, where N is the size of the convolutional filter in one dimension. as described supra, the convolution operation is followed by a Layer Normalization (LayerNorm) and a Gaussian Error Linear Unit (GELU) activation function.

As described supra, the condition embedding vector generated at the conditional embedding branch 220 are fed into a particular Conv 1×N Block, which, in this example, is the Conv 1×N Block 211-3. Accordingly, the Conv 1×N Block 211-3 receives two inputs: the output from the Conv 1×N Block 211-2 and the intermediate output from the conditional embedding branch 220. Inside the Conv 1×N Block 211-3, these two inputs are concatenated along a specific dimension before being processed by the convolution operation.

As such, the input signal passes through the Conv 1×N blocks 211-1 to 211-P. The output of the Conv 1×N block 211-P is then processed by the last Conv 1×1 block 212. Additionally, the original input signal (Input 2) is directly connected to the last Conv 1×1 block (212).

The final output of the main NN architecture 210 is a tensor vector with the same shape as the input signal, i.e., [Batch size, 1, 1024, 2]. This output represents the simulated amplified signal, aiming to closely match the behavior of the real power amplifier (PA) for the given input signal under the specified PA conditions.

The PAN 202 is trained using a training flow that involves feeding both Input 1 (the condition indication) and Input 2 (the signal) simultaneously into the network. The training process aims to optimize the weights of the neural network components, including the conditional embedding branch 220 and the main NN architecture 210, to accurately simulate the behavior of a real power amplifier (PA).

During training, the condition indication (Input 1), which represents the PA configuration settings, is fed into the conditional embedding branch 220. Concurrently, the input signal (Input 2) is fed into the main NN architecture 210. This output from the main NN architecture 210 represents the simulated amplified signal, aiming to closely match the behavior of the real PA for the given input signal and PA conditions.

During training, the output of the PAN 202 is compared against the output of the real PA using the cost function 160. The cost function 160 measures the difference or error between the simulated output and the real PA output. This error is then used to update and optimize the weights of the neural network components in the PAN 202 through, for example, backpropagation and gradient descent techniques.

The training process iteratively adjusts the weights of the conditional embedding branch 220 and the main NN architecture 210 to minimize the error between the simulated output and the real PA output. By updating the weights based on the cost function 160, the PAN 202 learns to accurately simulate the behavior of the real PA under various operating conditions.

The training flow simultaneously updates both the conditional embedding branch 220 and the main NN architecture 210, allowing the PAN 202 to learn the relationship between the PA conditions and the corresponding signal processing. This joint optimization enables the PAN 202 to adapt to different PA configurations and generate accurate simulations.

Through this training process, the PAN 202 becomes a generalized model capable of simulating the behavior of a PA under a wide range of operating conditions, as specified by the condition indication. The trained PAN 202 can then be used to efficiently simulate and optimize PA behavior in various applications, such as wireless communication systems, without the need for multiple separate models for different PA conditions.

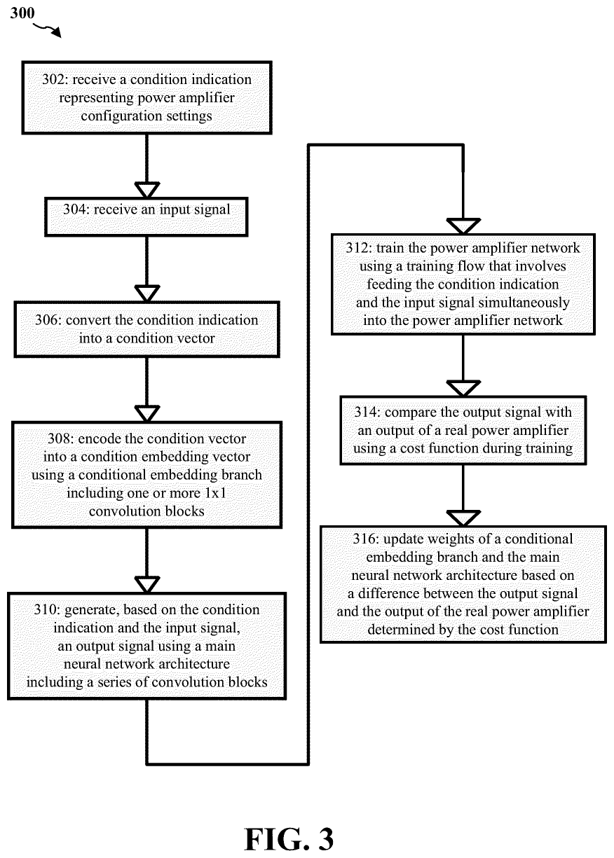

FIG. 3 is a flow chart 300 of a method (process) for operating a power amplifier network. The method may be performed by a computing device. In operation 302, the computing device receives a condition indication representing power amplifier configuration settings. The power amplifier configuration settings may include one or more of a band, a modulation, a constellation type, a resource block allocation, a central frequency, an output power level, a mobile industry processor interface (MIPI) control setting, or a supply voltage.

In operation 304, the computing device receives an input signal. In certain configurations, the input signal is a tensor vector having a shape of [Batch size, 1, 1024, 2], where the batch size is a number of signal instances processed simultaneously.

In operation 306, the computing device converts the condition indication into a condition vector. In operation 308, the computing device encodes the condition vector into a condition embedding vector using a conditional embedding branch including one or more 1×1 convolution blocks. In certain configurations, the condition embedding vector is a tensor vector having a shape of [1, 1024, 8].

In operation 310, the computing device generates, based on the condition indication and the input signal, an output signal using a main neural network architecture including a series of convolution blocks. The output signal simulates an amplified signal in accordance with the input signal and the power amplifier configuration settings. In certain configurations, the condition embedding vector is fed into the main neural network architecture at a specific convolution block.

In certain configurations, one or more of the series of convolution blocks each include a 1×N convolution followed by a layer normalization and a Gaussian error linear unit (GELU) activation function. In certain configurations, one or more initial convolution blocks of the series of convolution blocks use a 1×7 or 1×5 convolution. In certain configurations, the main neural network architecture further includes a final 1×1 convolution block that receives an output from a last convolution block of the series of convolution blocks and the input signal. In certain configurations, the output signal is a tensor vector having the shape of [Batch size, 1, 1024, 2].

In operation 312, the computing device trains the power amplifier network using a training flow that involves feeding the condition indication and the input signal simultaneously into the power amplifier network. In operation 314, the computing device compares the output signal with an output of a real power amplifier using a cost function during training. In operation 316, the computing device updates weights of a conditional embedding branch and the main neural network architecture based on a difference between the output signal and the output of the real power amplifier determined by the cost function. In certain configurations, the training flow is performed iteratively until the difference between the output signal and the output of the real power amplifier is below a threshold.

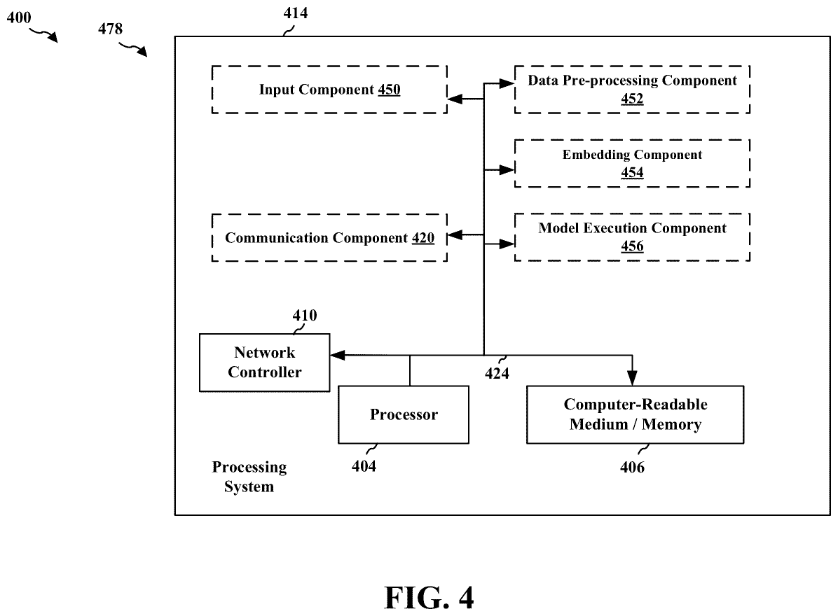

FIG. 4 is a diagram 400 illustrating an example of a hardware implementation for an apparatus 478 employing a processing system 414. The apparatus 478 may implement an input component 450, a data pre-processing component 452, an embedding component 454, a model execution component 456. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware components, represented by a processor 404, a network controller 410, and a computer-readable medium/memory 406. The bus 424 may also link various other circuits such as timing sources, peripherals, voltage regulators, and power management circuits, which are well known in the art, and therefore, will not be described any further.

The processing system 414 may be coupled to the network controller 410. The network controller 410 provides a means for communicating with various other apparatus over a network. The network controller 410 receives a signal from the network, extracts information from the received signal, and provides the extracted information to the processing system 414, specifically a communication component 420 of the apparatus 478. In addition, the network controller 410 receives information from the processing system 414, specifically the communication component 420, and based on the received information, generates a signal to be sent to the network. The processing system 414 includes a processor 404 coupled to a computer-readable medium/memory 406. The processor 404 is responsible for general processing, including the execution of software stored on the computer-readable medium/memory 406. The software, when executed by the processor 404, causes the processing system 414 to perform the various functions described supra for any particular apparatus. The computer-readable medium/memory 406 may also be used for storing data that is manipulated by the processor 404 when executing software. The processing system further includes the input component 450, the data pre-processing component 452, the embedding component 454, the model execution component 456. The components may be software components running in the processor 404, resident/stored in the computer readable medium/memory 406, one or more hardware components coupled to the processor 404, or some combination thereof.

The apparatus 478 may include means for performing operations as described supra referring to FIG. 3. The aforementioned means may be one or more of the aforementioned components of the apparatus 478 and/or the processing system 414 of the apparatus 478 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of a power amplifier network, comprising:
receiving a condition indication representing power amplifier configuration settings;
receiving an input signal; and
generating, based on the condition indication and the input signal, an output signal using a main neural network architecture including a series of convolution blocks, the output signal simulating an amplified signal in accordance with the input signal and the power amplifier configuration settings.

2. The method of claim 1, wherein the power amplifier configuration settings include one or more of a band, a modulation, a constellation type, a resource block allocation, a central frequency, an output power level, a mobile industry processor interface (MIPI) control setting, or a supply voltage.

3. The method of claim 1, further comprising:
converting the condition indication into a condition vector; and
encoding the condition vector into a condition embedding vector using a conditional embedding branch including one or more 1×1 convolution blocks.

4. The method of claim 3, wherein the condition embedding vector is a tensor vector having a shape of [1, 1024, 8].

5. The method of claim 3, wherein the condition embedding vector is fed into the main neural network architecture at a specific convolution block.

6. The method of claim 1, wherein one or more of the series of convolution blocks each include a 1×N convolution followed by a layer normalization and a Gaussian error linear unit (GELU) activation function.

7. The method of claim 6, wherein one or more initial convolution blocks of the series of convolution blocks use a 1×7 or 1×5 convolution.

8. The method of claim 1, wherein the input signal is a tensor vector having a shape of [Batch size, 1, 1024, 2], where the batch size is a number of signal instances processed simultaneously.

9. The method of claim 8, wherein the output signal is a tensor vector having the shape of [Batch size, 1, 1024, 2].

10. The method of claim 1, wherein the main neural network architecture further includes a final 1×1 convolution block that receives an output from a last convolution block of the series of convolution blocks and the input signal.

11. The method of claim 1, further comprising training the power amplifier network using a training flow that involves feeding the condition indication and the input signal simultaneously into the power amplifier network.

12. The method of claim 11, further comprising comparing the output signal with an output of a real power amplifier using a cost function during training.

13. The method of claim 12, further comprising updating weights of a conditional embedding branch and the main neural network architecture based on a difference between the output signal and the output of the real power amplifier determined by the cost function.

14. The method of claim 12, wherein the training flow is performed iteratively until the difference between the output signal and the output of the real power amplifier is below a threshold.

15. A computing device, comprising:
a memory; and
at least one processor coupled to the memory and configured to:
receive a condition indication representing power amplifier configuration settings;
receive an input signal; and
generate, based on the condition indication and the input signal, an output signal using a main neural network architecture including a series of convolution blocks, the output signal simulating an amplified signal in accordance with the input signal and the power amplifier configuration settings.

16. The computing device of claim 15, wherein the power amplifier configuration settings include one or more of a band, a modulation, a constellation type, a resource block allocation, a central frequency, an output power level, a mobile industry processor interface (MIPI) control setting, or a supply voltage.

17. The computing device of claim 15, wherein the at least one processor is further configured to:
convert the condition indication into a condition vector; and
encode the condition vector into a condition embedding vector using a conditional embedding branch including one or more 1×1 convolution blocks.

18. The computing device of claim 17, wherein the condition embedding vector is a tensor vector having a shape of [1, 1024, 8].

19. The computing device of claim 17, wherein the condition embedding vector is fed into the main neural network architecture at a specific convolution block.

20. A computer-readable medium storing computer executable code for operation of a computing device, comprising code to:
receive a condition indication representing power amplifier configuration settings;
receive an input signal; and
generate, based on the condition indication and the input signal, an output signal using a main neural network architecture including a series of convolution blocks, the output signal simulating an amplified signal in accordance with the input signal and the power amplifier configuration settings.
